(19) United States
(12) Patent Application Publication
(10) Pub. No.: US 2018/0053433 A1
(43) Pub. Date: Feb. 22, 2018

(54) SYSTEM AND METHOD FOR PROVIDING AN ADAPTIVE SCENARIO-BASED USER EXPERIENCE

(71) Applicant: Robert Dunn, Longwood, FL (US)

(72) Inventor: Robert Dunn, Longwood, FL (US)

(21) Appl. No.: 15/597,755

(22) Filed: May 17, 2017

Related U.S. Application Data
(60) Provisional application No. 62/377,286, filed on Aug. 19, 2016.

(51) Int. Cl. G09B 5/12; A63F 13/803; A63F 13/67; G09B 7/00; A63F 13/69

(52) U.S. Cl. CPC G09B 5/12; A63F 13/803; A63F 13/69; G09B 7/00; A63F 13/67

(57) ABSTRACT

A system for providing an adaptive scenario-based user experience includes a scenario complexity determination unit that stores and disseminates scenarios in the form of individual lessons having a numeric scenario complexity level for teaching a learning objective. The system includes an instructor platform for controlling an operation of the scenario complexity determination unit, and a student platform for receiving the disseminated scenarios. The scenario complexity determination unit is encoded with instructions for selecting subsequent scenarios for dissemination to the student platform based on the received performance result.

### CROSS-REFERENCE TO RELATED APPLICATIONS

This application claims the benefit of U.S. Application Ser. No. 62/377,286, filed on Aug. 19, 2016, the contents of which are incorporated herein by reference.

### TECHNICAL FIELD

The present invention relates generally to teaching, learning and gaming methodologies, and more particularly to a method and system for adapting scenarios based on user performance.

### BACKGROUND

The statements in this section merely provide background information related to the present disclosure and may not constitute prior art.

As shown in background FIG. 1, whether someone is learning a new skill or playing a video game, the method by which they progress from beginning to end is typically defined by a pre-set schedule wherein the user moves from one pre-determined point to another.

For example, within a teaching environment, lessons are arranged sequentially from an “expert's” opinion of least difficult to most difficult. To this end, once each level is mastered by a student they move to the next level, regardless of how well or poor they performed in the previous level. Likewise, within the gaming industry all players begin at level 1, secure the objective, then progress to level 2, and so on, until all of the levels have been beaten sequentially.

In both cases, the order of lessons/levels do not change based on the actual performance of the user in the previous level/lesson. This lack of adaptiveness results in lost time and effort wherein students can become bored and lose motivation to continue.

Accordingly, it would be beneficial to provide a system and method for providing an adaptive scenario-based user experience that can adapt subsequent steps based on the previous and/or current performance of a user, so as to avoid the drawbacks described above.

### SUMMARY OF THE INVENTION

The present invention is directed to a system for providing an adaptive scenario-based user experience. One embodiment of the present invention can include a scenario complexity determination unit can store and disseminate scenarios. Each of the scenarios can include an individual lesson having a numeric scenario complexity level for teaching a learning objective.

Another embodiment of the present invention can include an instructor platform for controlling an operation of the scenario complexity determination unit, and a student platform for receiving the disseminated scenarios. In one embodiment, the scenario complexity determination unit can select a subsequent scenario for dissemination to the student platform based on the received performance result.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a flowchart representing a teaching method in accordance with the background art.

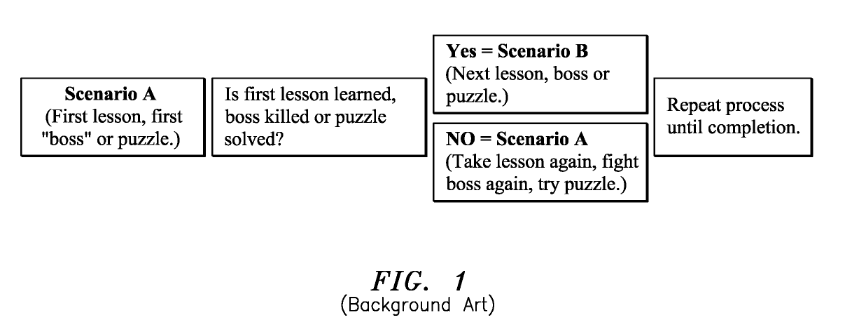

FIG. 2 is a simplistic block diagram of an exemplary operating environment for the system and method for providing an adaptive scenario-based user experience, in accordance with one embodiment of the invention.

FIG. 3 is a flowchart illustrating a method for providing an adaptive scenario-based user experience, in accordance with one embodiment of the invention.

FIG. 4 is a flowchart illustrating a method for determining the Scenario Complexity value (SC) for use with the system and method of providing an adaptive scenario-based user experience, in accordance with one embodiment of the invention.

FIG. 5 is a flowchart illustrating method of determining the Task Complexity of a base element used in the system and method of providing an adaptive scenario-based user experience, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Through extensive research and development, the inventor of the presently claimed invention has developed a system and method for providing an adaptive scenario-based user experience that can adapt any method of teaching, learning, or game play based on the previous and current performance of a user. Such a feature can function to keep a user motivated by being presented with scenario's that are not too hard or too easy but rather in the “Goldilocks zone” of just right.

As will be described below, the system and method can function to identify a number, or value, that determines how complex a particular scenario is. The higher the value, the more complex the scenario. This value can then be used as the baseline to determine the next scenario presented. The user's performance (failure/success) dictates a decrease or increase in the complexity value range of the next scenario chosen from a scenario library.

### Definitions

As described herein, the term “scenario” can include information that is selectively encountered by a user based on the below described methodology. Within a teaching environment, scenarios can include individual lessons, for example, that would previously have been arranged sequentially. Within a video game environment, scenarios can include individual levels that would also have previously been arranged sequentially.

As described herein, the term “scenario library” can include a plurality of individual scenarios which can be stored within the below described scenario complexity determination unit for selective application to users based on the calculated scenario complexity value.

As described herein, the term “Adaptive Automation (AA)” can include computer functionality for using the performance of the user to guide the scenario sequencing process.

As described herein, the term “Base Variables” can include a plurality of individual variables that are used to calculate the values of the scenario's characteristic.

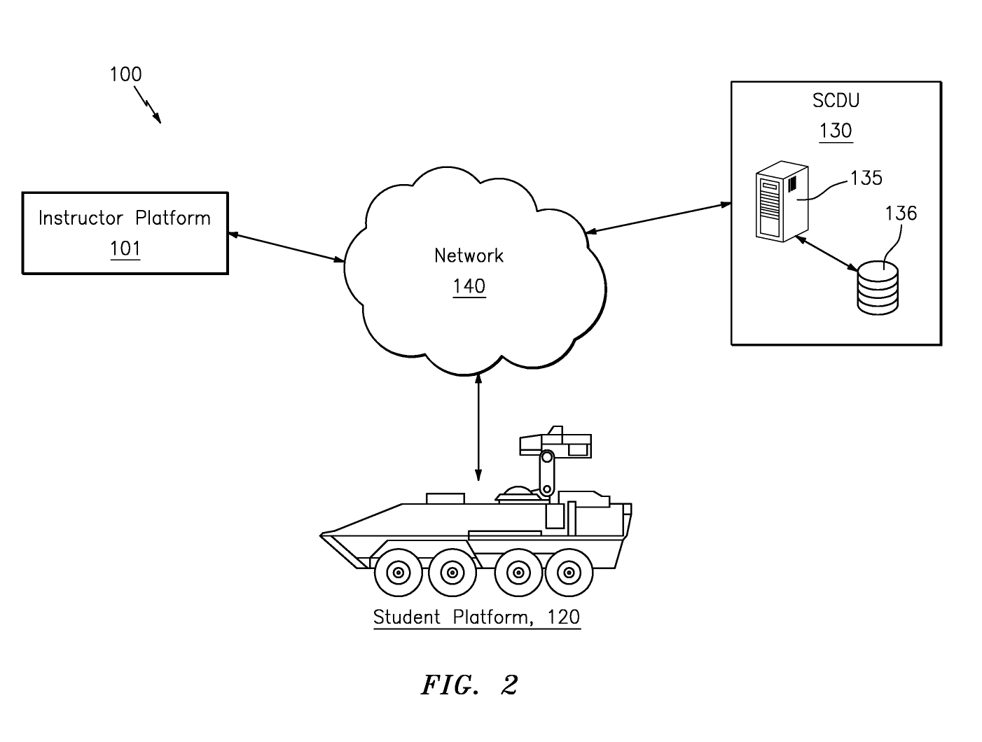

Various systems and methods for providing adaptive scenario-based user experiences will be provided below with respect to FIGS. 2-5. Although described with regard to a military training environment, this is for illustrative purposes only, so as to provide a clear understanding of the system and method functionality. As such, those of skill in the art will recognize that the inventive concepts described herein can be equally applied to any number of other situations wherein a student is learning a new skill and/or a user is progressing through a video game, respectively, for example.

FIG. 2 is a schematic illustration of an exemplary system for providing an adaptive scenario-based user experience. As shown, the system 100 can include an instructor platform 101, a student platform 120, and a scenario complexity determination unit 130 (SCDU) that are connected over a network 140.

The instructor platform 101 can include any number of computing devices having a user interface capable of exchanging information with a user. As will be described below, the instructor platform can function to allow an instructor to enter/modify information that is used to calculate the scenario complexity of a student platform 120, so as to guide the student through a training evolution. In one nonlimiting example, the instructor platform can include, for example, a simulator control room for use in training military crews.

The student platform 120 can also include any number of computing devices having a user interface/actuation unit capable of exchanging information with a user. In the preferred embodiment, the student platform can include, comprise or consist of a military vehicle simulator, for example, that can be used by a military training regimen (via the instructor platform) to train individual crew members and/or entire crews how to operate and/or fight the vehicle. To this end, the actuation unit can include each of the controls that would be found in the real world vehicle, and the display can show images that would be seen out the vehicles viewing areas.

In one embodiment, the student platform 120 can be provided within an actual vehicle such as a Light Armored Vehicle-Anti Tank (LAV-AT), for example, and can be integrated with the vehicle systems, so as to be remotely coupled to an instructor unit 101 via the below described network. Such a feature can allow the tank crew to experience just-in-time training for new procedures and/or weapons in a real world environment utilizing the adaptive scenario-based user experience.

The complexity determination unit 130 can function to control the training experience of the student platform 120 by selectively applying individual scenarios that are stored within the scenario library. The exact order in which individual scenarios will be presented to the student platform are based upon input from the instructor platform 101 and the below described SCT algorithm.

As such, the complexity determination unit can also include one or more individual computing devices 135 that are coupled to any number of dedicated memory units 136 on which the scenario library and SCT algorithm reside. With regard to military applications, and particularly where the student platform 120 is positioned within a real vehicle, such as the LAV-AT, for example, the complexity determination unit 130 will most preferably comprise or consist of a purpose built non-generic computing device having integrated encryption for accessing scenarios and/or facilitating secure communication between the instructor platform and the student platform.

The network 140 can include any type of transmission medium that can facilitate communication between the instructor platform 101, the student platform 120 and the complexity determination unit 130. Several nonlimiting examples include, but are not limited to various forms of digital or analog communication, packet-based networks and/or circuit-based networks, for example, in any configuration. In one embodiment, the network can include, comprise or consist of an encrypted military communications network.

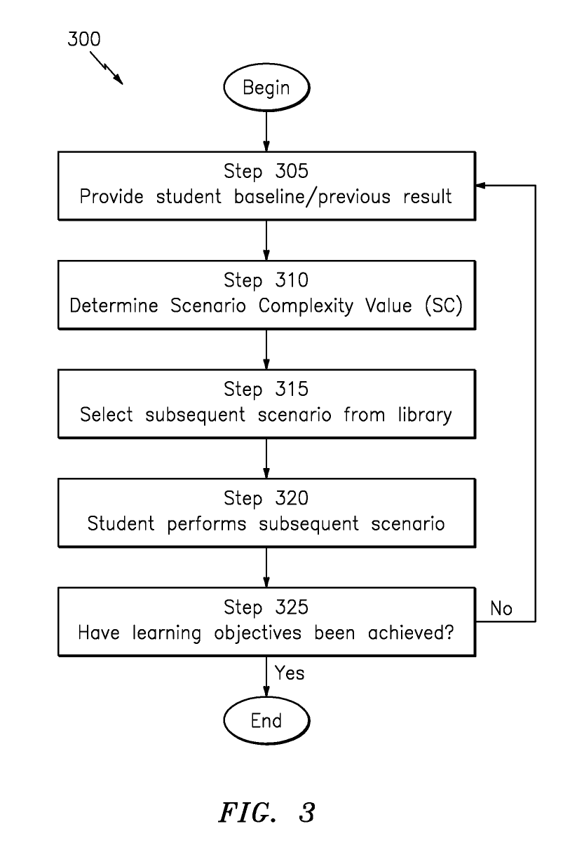

FIG. 3 illustrates one method for providing adaptive scenario-based user experiences utilizing the above noted system 100. Although described below with regard to particular method steps, those of skill in the art will recognize that the steps may be carried out in different order and/or substituted of similar steps based upon the actual scenario in which the method is being performed (e.g., military training, non-military training, gaming, etc.,).

As shown, the method 300 can begin at step 305, wherein a baseline performance or previous scenario performance result (of below described step 320) of a student can be received by the complexity determination unit 130.

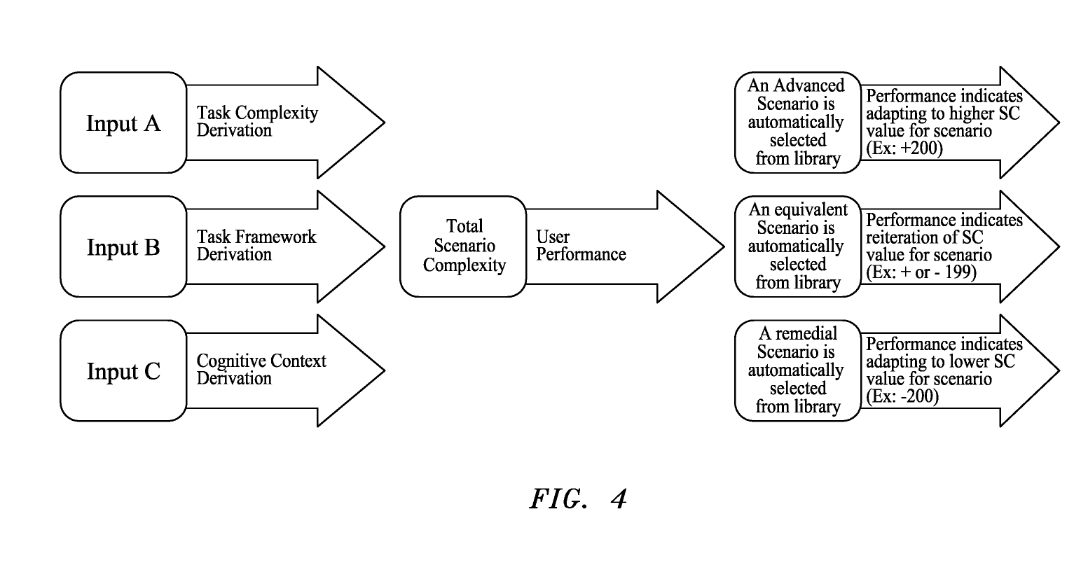

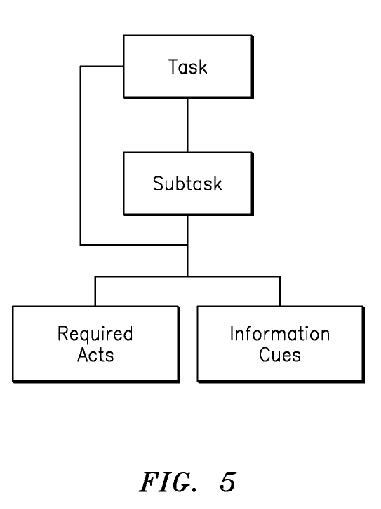

Next, the method can proceed to step 310, wherein the complexity determination unit 130 can determine a numeric Scenario Complexity value (SC). This process is explained in detail below with regard to FIGS. 4 and 5.

Next, the method can proceed to step 315, wherein the complexity determination unit 130 and/or an instructor utilizing the instructor platform 101 can select a specific scenario from the scenario library based on the outcome from step 310. For example, if the most recent scenario performed by the student had a value of 100, and the student performed well, e.g., a passing score of 80 or higher, for example, the complexity determination unit 130 can recommend that the next scenario to be performed by the student have a higher SC value, such as 145-155, for example. Conversely, if the student did not perform well, e.g., a failing score of below 80, for example, the complexity determination unit 130 can recommend that the next scenario to be performed by the student have a lower SC value, such as 45-55, for example.

In either instance, the method can next proceed to step 320, wherein the student can utilize the student platform 120 to perform the scenario selected in step 315 and can be assigned a performance result (e.g., grade).

If the student successfully completes the scenario, and all learning objectives have been met, the method can proceed to step 325 and terminate. Alternatively, if the student does not successfully complete the selected scenario, and/or the learning objectives have not been met, the method can return to step 305, wherein the outcome of step 320 can be used as an input for step 305.

FIG. 4 provides an exemplary flowchart overview for calculating a scenario complexity value for use in the method described above. As shown, a scenario's level of complexity has three characteristics, which can be defined as: Task Complexity (TC), Task Framework (TF), and Cognitive Context Moderators (CCM). Each of these characteristics can be utilized to calculate a numerical Total Scenario Complexity Value (SC) as follows:

SC=TC×CCM+TF

As noted above, when the SC value is determined the system can provide students with subsequent scenarios having an SC value range that is adapted based on the students individual performance and/or progression through the training evolution. In this way, variation and uniqueness of each training evolution are limited only by the size of the scenario library and/or the learning objectives, thereby ensuring a different and unique training experience for each student.

### Task Complexity

As shown in FIG. 5, the first characteristic-Task Complexity can be made up of three base variables that include Subtasks, Required Acts, and Information Cues. Each of these base variables can be utilized to form a numeric Task Complexity value (TC), for use in calculating the Total Scenario Complexity. In the preferred embodiment, the Task Complexity can be calculated as follows:

TC=TC₁*TC₂
TC₁=sum of required acts in each task+sum of information cues
TC₂=(# subtasks)̂(# of interdependent subtasks where # of interdependent subtasks is 10 or less)
TC₂=(# subtasks)*(# of interdependent subtasks where # of interdependent subtasks is greater than 10)

A Subtask is a task necessary to perform the main task. If no subtask is necessary, a task could stand alone. Both task and subtask must have a clear duration, a desired outcome or objective, and measures of performance. In operation, an instructor utilizing the instructor platform 101 can provide the subtasks to the scenario complexity determination unit 130 which can utilize the above described TC formula to calculate a numerical Task Complexity value.

A Required Act is different from other acts and is necessary for the successful completion of the task or subtask. For example, one such task can include moving a tank to an alternative battle position. For the driver, navigation and steering subtasks are involved in this task. The navigation subtask requires the act of observing the terrain; the subtask of steering requires the act of turning the driver's wheel. In operation, an instructor utilizing the instructor platform 101 can provide the required acts to the scenario complexity determination unit 130 which can utilize the above described TC formula to calculate a numerical Task Complexity value.

An Information Cue is information that must be monitored and processed in order to complete the task/subtask. For the gunner of a tank, the task of identifying a target includes the subtask of scanning; this subtask requires the trainee to monitor both right and left lateral limits. In operation, an instructor utilizing the instructor platform 101 can provide the information cues to the scenario complexity determination unit 130 which can utilize the above described TC formula to calculate a numerical Task Complexity value.

Task Coordination accounts for coordinating subtasks and required acts necessary for task completion. When driving, the subtasks of steering and navigation are coordinated; the successful completion of steering (subtask-A) requires the successful completion of navigation (subtask-B) and completion of subtask-B requires the completion of subtask-A.

### Task Framework

The second characteristic-Task Framework can depend on whether a task is well- or poorly-defined by determining the number of task paths and task outcomes. Task framework accounts for the relation between task paths and the outcome associated with each, and addresses which outcomes are possible in a given task by considering four base variables: Task Path, Task Outcome, Conflicting Outcomes and Unknown Outcomes. Each of these base variables can be utilized to form a numeric Task Framework value (TF), for use in calculating the Total Scenario Complexity. In the preferred embodiment, the Task Framework can be calculated as follows:

TF Formula:

| | |
|---|---|
| TF | sum from i + 1 to N of TFi |
| TFi | p^{u} + o (while u = less than 10) p * u + o |
| | ⁽while u = greater than 10) |
| p | # of paths in task i |
| u | degree of uncertainty/conflicts in the |
| | paths in task i |
| o | # of criteria that must be satisfied in task i |

A Task Path is the number of ways to arrive at the objective depending on the existing conditions. Having several ways to reach the objective increases the complexity of a task because efficiency is often a criterion of performance. In operation, an instructor utilizing the instructor platform 101 can provide the task paths that are present in the scenario to the scenario complexity determination unit 130 which can utilize the above described TF formula to calculate a numerical Task Framework value.

A Task Outcome is defined as a measurement that must be satisfied in order to reach the desired objective, such as performing a procedure in proper order. In operation, an instructor utilizing the instructor platform 101 can provide the Task Outcomes to the scenario complexity determination unit 130 which can utilize the above described TF formula to calculate a numerical Task Framework value.

A Conflicting Outcome is when achievement of one objective can conflict with achieving another. For example, driving may include the objective of getting to a destination quickly versus the objective of not violating road laws. In operation, an instructor utilizing the instructor platform 101 can provide the Conflicting Outcomes to the scenario complexity determination unit 130 which can utilize the above described TF formula to calculate a numerical Task Framework value.

Unknown Outcomes account for the increase in mental processing as a result of not knowing whether certain paths will lead to certain outcomes. For example; the mental processing of “can I get there fast enough, should I ignore road signs etc” is spending cognitive resources choosing a path that meets the objective by evaluating the chance that each path will allow for success given the existing conditions. In operation, an instructor utilizing the instructor platform 101 can provide the Unknown Outcomes to the scenario complexity determination unit 130 which can utilize the above described TF formula to calculate a numerical Task Framework value.

### Cognitive Context Moderators

The third characteristic-Cognitive Context Moderators, or distractors, addresses the degree of stress and distraction the trainee may feel. Distractors are external factors that increase mental processing and/or reduce mental resources for the task. Distractors may cause less complex tasks to appear more complex. For example, driving in daylight is a less complex task than driving at night. In operation, an instructor utilizing the instructor platform 101 can provide the number of Cognitive Context Moderators (CCM) to the scenario complexity determination unit 130 as a whole number for use in calculating the Total Scenario Complexity.

Accordingly, the above described system and method for providing an adaptive scenario-based user experience allows the progression of any form of training or game play to conform to a students' individual performance on preceding steps/levels.

With particular respect to military training applications, such a system and method represents a substantial departure from traditional teaching methodologies by providing steps that are not routine or conventional in the field. Moreover, by linking the system and method to a particular machine within a particular technological environment, such as a purpose built, standalone scenario complexity determination unit 130 and/or by utilizing a military vehicle as the student platform 120, the system adds unconventional steps that confines the same to a particular useful application (e.g., remotely providing just-in-time training).

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, aspects of the present invention may be embodied as a system, method or computer program product. Accordingly, aspects of the present invention may take the form of an entirely hardware embodiment, or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system for providing an adaptive scenario-based user experience, said system comprising:
a scenario complexity determination unit that includes one or more computing devices each having a physical memory bearing instructions that, upon execution by the one or more computing devices disseminates scenarios, said scenarios comprising a plurality of individual lessons having a numeric scenario complexity level for teaching a learning objective;
an instructor platform for controlling an operation of the scenario complexity determination unit; and
a student platform for receiving the disseminated scenarios, said student platform comprising a display unit, an actuation unit, and a communication unit,
wherein the scenario complexity determination unit is encoded with instructions for receiving a scenario performance result from the communication unit, and selecting a subsequent scenario for dissemination to the student platform based on the received performance result.

2. The system of claim 1, wherein the student platform includes:
a vehicle simulator.

3. The system of claim 1, wherein the complexity determination unit includes:
at least one database containing a library of scenarios.

4. The system of claim 1, wherein the instructor platform includes:
a simulator control room.

5. The system of claim 1, wherein the scenario complexity determination unit is encoded with instructions for selecting a subsequent scenario having a higher numeric scenario complexity level upon receiving a first performance result.

6. The system of claim 5, wherein the scenario complexity determination unit is encoded with instructions for selecting a subsequent scenario having a lower numeric scenario complexity level upon receiving a second performance result.

7. The system of claim 6, wherein the first performance result represents a passing score, and the second performance result represents a failing score.

8. The system of claim 7, wherein the scenario complexity determination unit is encoded with instructions for determining the numeric scenario complexity level based on a task complexity number.

9. The system of claim 8, wherein the scenario complexity determination unit is encoded with instructions for determining the numeric scenario complexity level based on a task framework number.

10. The system of claim 9, wherein the scenario complexity determination unit is encoded with instructions for determining the numeric scenario complexity level based on a cognitive context moderator number.

11. The system of claim 10, wherein the scenario complexity determination unit is encoded with instructions for determining the numeric scenario complexity level by multiplying the task complexity number with the cognitive context moderator number, plus the task framework number.
